(19) United States
(12) Patent Application Publication
(10) Pub. No.: US 2010/0133838 A1
(43) Pub. Date: Jun. 3, 2010

(54) Turbine rotor and power plant

(75) Inventor: Eystein Borgen, Stavanger (NO)

Correspondence Address: ATLANTIC RICHFIELD COMPANY;F. J. UXA, 400 E. SIBLEY BLVD., HARVEY, IL, 60426, US

(73) Assignee: SWAY AS, Stavanger (NO)

(21) Appl. No.: 12/595,517

(22) PCT Filed: Apr. 12, 2007
(86) PCT No.: PCT/NO2007/000132

§ 371 Date: Jan. 11, 2010

(51) Int. Cl. H02K 7/18; F03D 9/00; H02K 7/09; F03D 1/06; B63H 1/20; F03B 3/12

(52) U.S. Cl. 290/52; 290/55; 310/90.5; 416/93 R; 416/93 A

(57) ABSTRACT

A turbine rotor for a wind or hydropower plant or for propulsive means for a vessel where the turbine rotor comprises a generally doughnut-shaped hub. The doughnut-shaped hub is configured as a closed, hollow profile in a cross section B, and wherein the doughnut-shaped hub is formed either in the shape of a torus, the torus being circularly shaped in cross section B and the torus being ring-shaped in cross section A wherein the outer and inner circumferences of the ring are circular, or in the shape of a quasi-torus, the quasi-torus being polygonally or circularly shaped in cross section B and the torus being ring-shaped in cross section A wherein the outer and inner circumferences of the ring are polygonally or circularly shaped, on which torus or quasi-torus at least one rotor blade is provided. There is also provided a wind, hydro or tidal plant comprising the turbine rotor.

The present invention relates to a turbine rotor for a wind, hydro or tidal power plant and a wind or hydropower plant comprising such a turbine rotor. The present invention also relates to the use of the turbine rotor for a wind or hydropower plant or as a propulsive means on a vessel. Briefly, the turbine rotor comprises, in a front view, a large-diameter, substantially “doughnut-shaped” or ring-shaped rotor hub consisting of a closed and hollow torsion-proof profile on which the rotor blades are arranged.

The development of windmills or wind turbines for generating power, preferably in the form of electric power, has steadily moved in the direction of larger mills. Windmills with an output of about 5 MW and a rotor diameter of more than 115-125 m have now been designed and constructed. Windmills as large as 5 MW and more are designed primarily with a view to being installed offshore owing to the difficulties of transporting such large mills on land. The principles of these horizontal-axis windmills are virtually the same as those of their smaller sisters. They are based on a rotor consisting of typically three blades mounted on a central hub with shaft, the shaft being secured by a heavy-duty ball bearing. The hub must be dimensioned to withstand substantial bending moments due to both the wind forces on each individual blade in the wind direction and the dead weight of each blade in a plane substantially at right angles to the wind with constantly varying direction depending on whether the blade is on its way up or down in its rotational path. If each blade has a different load from the wind at a given instant, a moment will be produced which will try to turn the hub about an axis at right angles to the longitudinal axis of the shaft. This moment can in extreme cases be exceptionally large and the shaft must also be dimensioned to withstand such a moment. The central hub and the shaft also transfer the torque of the rotor directly or via a gear to the generator.

Maintenance costs for offshore windmills are initially greater than for land-based windmills. An interruption in the energy production as a consequence of a fault in many cases also has greater consequences offshore because the weather conditions often do not permit boarding of the windmills to carry out the necessary repairs. Far out at sea, the wind conditions are also as a rule considerably stronger than on land. If it is desired to harvest as much of this energy as possible by increasing the nominal wind speed at which the blades are turned out of the wind, the wind power plant will be subjected increased fatigue loads compared to a location in calmer wind conditions.

Large windmills or wind turbines have the advantage that maintenance and “one-off costs” such as control systems etc. per kWh of produced energy unit can be expected to be reduced. The disadvantage is that weight and material consumption increase per kWh of power produced in the case of such large mills. The optimal economic size of a land-based windmill is with today's technology estimated by many to be about 1-3 MW.

The reason that weight and material consumption increase per produced energy unit with the increasing size of the windmill is that the weight increases approximately by the third power of the longitudinal dimension (volumetric increase) whilst the sweep area of the rotor (defined as the area of the circle that encircles the rotor blades as they rotate), and thus the energy production, only increases by the square of the longitudinal dimension. This implies a comparison of a given location where the wind strength is the same in both cases. I.e., if it is desired to increase the size of the windmill whilst using the same technology as before, the weight per energy unit produced, and thus to a great extent the costs, will increase approximately linearly with the size of the windmill.

In addition, the rotational speed (angular velocity) will be reduced with increasing windmill rotor diameter. This is because the optimal blade tip speed is given as a function of the wind speed. The optimal ratio between blade tip speed and wind speed, hereafter referred to as the tip speed ratio, will, for a three-bladed windmill, normally be in the order of 6 depending on the length/breadth ratio of the blades. When the wind speed is the same, the angular velocity of the rotor will therefore decrease for a windmill with larger rotor diameter. The output produced, if losses are disregarded, is the product of the angular velocity of the rotor and the torque of the rotor; P=M_{T}*ω, wherein P is output, M_{T} is torque and ω is angular velocity.

The increase in the torque which must be transferred from the aerodynamic rotor via the drive gear to an electrical generator when the power is increased by increasing the rotor diameter can then be estimated by the following considerations:

P=Cp*ρ*v³*A=Cp*ρ*v³*D²*π/4

wherein Cp is a constant, ρ is the density of the liquid or air, v is wind speed, A is the swept rotor area and D is the rotor diameter and

ω=v*6/(D*π)*2*π=12*v/D,

wherein 6 is the tip speed ratio.

Inserting for P and ω in the formula P=M_{T}*ω gives:

M_{T}=Cp*ρ*v³*D²*π*D/(4*12*v)=Cp*ρ*v²*D³*π/48

M_{T}=k*D³,

wherein k is constant for a given wind speed and air density.

Thus, like the weight of the rotor, the torque transferred from the rotor via the drive gear to the generator will increase by the third power of the rotor diameter whilst the output only increases by the square of the rotor diameter. This also means that the transmission (gearbox) is subjected to disproportionately large loads in the case of large windmills, and it will be an advantage to have a direct-drive solution for the generator. One problem is that the rotational speed is low in the case of large rotor diameters as described above, and there is instead a disproportionately large increase in necessary active material in the actual generator part for a direct-drive windmill with large rotor diameter. In addition, for direct-drive windmills it is difficult with today's technology to control the air gap between the stator and the electrical rotor part, which normally must be kept within +/−a couple of mm, owing to deflections of the main shaft.

The conditions described above illustrate the problem of increasing the rotor diameter of a windmill in order to increase output. Weight, and thus to a great extent the costs per kWh produced for a windmill in the megawatt class increases approximately linearly with the rotor diameter, which speaks against building larger windmills using today's known technology. In addition, air gap tolerances between stator and the electrical rotor are a problem for larger direct-drive generators. Fatigue in the blades and tower structure as a result of varying wind speeds are also a problem, in particular for floating installations.

The conditions mentioned above represent the most significant limitations for constructing windmills offshore that are substantially larger than 3-5 MW.

Of prior art in the field, mention can be made of WO 02/099950 A1 which discloses a turbine with a direct-drive generator, wherein the stator wheel and the rotor wheel are made according to the same principle as a bicycle wheel with spokes which at one end are fastened to an outer ring or rim and at the other end are fastened eccentrically to the hub. In this way, it takes up both radial and to a certain extent axial forces. However, in the description it is strongly stressed that the rotor wheel does not incorporate blades or any other means to extract power from the wind or water, and particularly it is stressed that blades are not mounted on the tension members. No mention is made in the description of a large-diameter hub with a closed and hollow torsion-proof profile.

DE 197 11 869 A1 discloses a wind turbine with a hollow, annular hub. The annular hub is split into two generally L-shaped parts, wherein one of the L-shaped parts is arranged on the tower and wherein the turbine blades are arranged on the other L-shaped part. The second L-shaped part is supported on the first L-shaped part by means of a bearing. Again, in the description there is no mention of large-diameter hub with a hollow and closed torsion-proof profile. Judging from the figures the L-shaped parts are formed from solid metal plates rather than hollow, closed profiles which means that this wind power plant will be unable to take up the torsional moments created by wind loads on the blades.

DE 102 55 745 A1 discloses a wind power plant where each blade is mounted to the hub with two bearings. According to the description must the distance between the two bearings be as large as possible in order to obtain obvious weight saving and the blades are mounted in conically shaped cavities in the hub. The way to obtain as large a distance as possible between the two bearings, one of the bearings must be positioned. The design of this wind power plant is therefore similar to conventional wind power plants as far as the hub and the attachment of the blades to the hub is concerned. Nothing is mentioned of the use of a large-diameter hub having a closed and hollow torsion-proof profile on which the blades of the turbine rotor is arranged.

WO 99/37912 A1 discloses an annular electrical machine comprising an annular rotor ring rotating within an annular stator ring. This invention is basically concerned with a propeller for a vessel or relatively small wind or water power plants with diameters of about 20 meters. As for the above mentioned prior art documents, nothing is mention of a large-diameter hub having a closed and hollow torsion-proof profile on which the blades of the turbine rotor is arranged. The annular shapes of the rotor ring and stator ring will be unsuitable for large scale power plants of the size that the present invention is concerned.

In the present application the term “turbine rotor” is used as a collective term for the rotating unit on a wind or hydropower plant which converts the energy in the water or the wind into mechanical energy that in turn is converted into electrical energy in the generator. The generator rotor where the magnets are mounted is also referred to as the electrical rotor. Turbine rotor is also used to refer to the propulsive means of the propulsion machinery of a vessel.

By the “active parts” of the generator is meant the parts which contribute to the energy conversion in the power plant.

By “ironless principles” is meant, in this invention, structural principles for generators which do not utilise ferromagnetic materials to conduct magnetic fields.

In the development of the present invention it has been an object to construct a cost-efficient integrated turbine rotor and generator for power plants, particularly wind power plants in the 5-15 MW class, with a substantial increase in rotor diameter, and thus energy production, without the previously associated, substantial increase in the weight of blades and hub and without the torque causing larger forces in the structure per kWh of energy produced.

It has also been an object that parts of the invention should be suitable for use in hydropower production, tidal water power and/or propulsion systems for boats and ships, where the turbine rotor is used as a propelling means for the vessel.

These objects are achieved with the present invention as disclosed in the independent claims. Alternative embodiments are disclosed in the dependent claims which are associated with each independent claim.

The basic idea that underlies the present invention is the use of a substantially “doughnut”-shaped hub which is formed as a hollow and closed profile. The blades of the turbine rotor are attached to the doughnut-shaped hub. It is important that the profile is hollow and closed in order to keep the weight of the doughnut-shaped hub low and at the same time provide the necessary strength and ability to take up bending moments, created by wind loads on the blades of the turbine rotor, which are transferred to the doughnut-shaped hub as torsional moments. A de-coupling of the radial and axial forces from the turbine rotor is also accomplished in the present invention whereas only radial forces are acting on the center bearing, thus eliminating that bending moments are transferred to the center bearing. As explained above, the wind turbines disclosed in the prior art documents above will be unable to accomplish these objectives, i.e. they are not able to take up the torsional moments and at the same time keep the weight sufficiently low for large sized wind power plants.

The doughnut-shaped hub generally has the shape of a torus which, for the present invention, has two important cross-sections. The cross-section denoted cross-section A herein, is a section through the hub which is perpendicular to the axis of rotation of the turbine rotor. This section creates a ring with two concentric circles if the hub has the shape of a torus. The diameter of the outer circle of the ring, or the circumscribing circle of the polygonally shaped ring (in a quasi-torus, see below), obtained in cross-section A is also called the large diameter of the torus or the quasi-torus. The other cross-section is herein denoted cross-section B and is the section taken in a plane which is parallel to the axis of rotation of the turbine rotor and in which plane the axis of rotation is lying. Cross-section B will consist of two circular shapes, symmetrically placed on either side of the axis of rotation of the turbine rotor, if the doughnut-shaped hub is a perfect torus. However, as will be explained in detail later, the doughnut-shaped hub of the turbine rotor does not have to be a perfect torus, but may be formed as a quasi-torus wherein cross-section A and/or cross-section B of the hub may be given a different shape, for instance a polygonal shape, particularly a regular polygonal shape, but is not limited to this shape. Other shapes of the cross-sections will also work. The shape of the profile of the hub, i.e. as can be seen in cross-section B, is however preferably formed with a shape such that the curvature of the curve that the profile describes has the same sign or is equal to zero (on a flat part of the profile) substantially around the entire circumference of the profile. Small “dents” in the profile of the hub taken in cross-section B may also be acceptable, but the larger the “dent” and the sharper the shape of the “dent”, the less effective will the doughnut-shaped hub be in taking up torsional moments. For example will a deep V-shaped “dent” in the hub substantially reduce the hubs capability to take up the torsional moments. Therefore the shape of the hub taken in cross-section B, is preferably circular or polygonal, for instance by using a box-shaped girder.

In a practical embodiment of a wind power plant, the doughnut-shaped hub has a diameter generally in the order of 10-20%, and at least 1/12 (=8.33%), of the rotor's diameter. The cross-section B of the ring has a diameter in the order of the diameter of the blades at their attachment to the hub, although it may be made both larger and smaller. One or more rotor blades are arranged against the doughnut-shaped hub. Since the rotor blades are terminated far out from the axis of rotation of the turbine rotor, the rotor blades will be shorter of length and subsequently the bending moments at the root of the blade are considerably smaller than for windmills having traditional hubs with corresponding rotor area. As explained, the hub consists of a doughnut-shaped hub which is designed to take up large torsional moments and bending moments simultaneously. That means to say that the dead weight of the blades is transferred as bending moment in the doughnut-shaped hub, whilst the bending moment that arises at the root of the blades owing to the wind forces is transferred as a torsional moment in the doughnut-shaped hub. The torque M_{T} of the turbine rotor which causes energy production in the generator is taken up directly in the stator without passing via a central shaft.

In one embodiment of the present invention, the shaft is therefore identical with the generator's stator and consists of a short annular ring with a large peripheral diameter, adapted to the peripheral diameter of the hub, arranged directly against the motor housing or supporting structure of the wind power plant. This means that the traditionally large torsional stresses M_{T} in the shaft, caused by the torque of the rotor, are substantially reduced and in practice eliminated as a problem.

The main bearing of the wind power plant of this embodiment, which is identical with the bearing of the electrical generator, consists in the present invention preferably of a stable magnetic bearing at the periphery of the hub.

The bearing may further consist of a magnetic axial bearing at the periphery of the hub combined with a radial mechanical center bearing. In that case, the magnetic bearing will be mounted between the doughnut-shaped hub and the stator ring where the axial forces are taken up, whilst the radial forces are taken up by arranging a spoke or plated system between the doughnut-shaped hub and a mechanical bearing arranged against the fixed structure of the windmill in the centre of the axis of rotation.

Optionally, a purely magnetic bearing can be used that takes up both axial and radial forces by using a Halbach array. According to Earnshaw's theorem, it is not possible to obtain a magnetically stable bearing solely by using permanent magnets (if superconductivity under extremely low temperatures is not used). This is described in more detail in U.S. Pat. Nos. 6,111,332 and 5,495,221. To circumvent Earnshaw's theorem about magnetic instability, either a passive magnetic bearing as described in the aforementioned two patents with a so-called Halbach array can be used for support of the hub, or optionally an active electromagnetic bearing with active servo control in order to obtain magnetic stability and damping. A hybrid solution with both permanent magnets and an active electromagnetic bearing with active servo control can also be used for support of the hub.

Alternatively, the hub may be equipped with a stable, passive magnetic bearing with the permanent magnets organised in a Halbach array, or optionally a similar configuration, which both has the function of a bearing for the hub and at the same time contains the active parts of the generator, i.e., magnets and electrical conductors in a direct-drive generator.

In both of the above cases, the electrical windings in the stator are preferably ironless (without a ferromagnetic core) in order to avoid substantial magnetic attraction forces in the generator. The generator stator contains both electrical windings for electric power production and optionally (when using a solely magnetic support with a Halbach array) electrical windings as a part of the magnetic bearings.

The same windings may optionally both have an electric power producing function and at the same time form wholly or partly the electrical windings which are required in the magnetically stable bearing.

The electrical windings in the stator are, as stated above, preferably ironless, but may contain iron in areas along the stator where such an extra magnetic attraction force is desired. For an alternative described above, the passive stable bearing consists of powerful permanent magnets arranged in a special system (Halbach array or similar system) on the hub or directly on the electrical rotor and electrical conductors which are arranged on the stator. When the magnets are set in motion, a current is produced in the electrical conductors which repels the magnets in the electrical rotor. The magnets are so positioned in 2 or 3 rows in the electrical rotor that the system is stable against both axial and radial external forces. There is further provided a mechanical support which supports the rotor until it has reached a sufficient speed for the magnetic bearing to become active. This will also be necessary in the cases where an electromagnetic bearing is used in the event of cuts in the power supply or faults in the servo control system. Rubber or other damping material with good damping properties can be used in connection with the attachment of the magnets to the structure in order to increase the damping properties of the magnetic bearing as described.

The closer the magnets are to the electrical conductors, the larger the repelling forces will be. By arranging the magnets in the electrical rotor in a Halbach array, it is possible to circumvent Earnshaw's theorem of magnetic instability and nevertheless obtain a magnetically stable bearing both radially and axially. The air gap may, for a generator based on the principles of an ironless Halbach array, be increased from a couple of mm to more than 20 mm where iron cores are used in the stator windings. Thus, according to the invention it is possible simultaneously to ease building and bending tolerances for the supporting structural parts of the generator in the wind power plant, which in connection with the prior art is a problem area, especially for large diameter wind power generators.

Strong permanent magnets are commercially available today, for example neodymium magnets, with a magnetic force of up to 50 tones per m² active face. Such magnets will be sufficient to take up all the relevant dimensioning forces in the bearings described for the rotor of the wind power plant. It is an advantage that the hub is of a large diameter according to this patent so that the moment arms are large in order to withstand different loads on the rotor, such as different distribution of wind forces on the different blades.

The hub with the electrical rotor and magnetic bearing and the stator may also be equipped with cooling ribs for direct air cooling from the air stream which passes through the central part of the open hub seen in the wind direction. The stator windings will preferably be embedded in a composite stator part without an iron core. This can advantageously be perforated so that water, oil, air or another suitable coolant can circulate around the stator windings. Optionally, natural circulation of air through such cooling holes may be sufficient cooling of the stator and/or if they are arranged on the electrical rotor also of the magnets in the rotor.

It will be possible to arrange the generator with the magnetic bearing inversely to the arrangement that has been described above. The magnets will then be in the stator and the electrical windings in the rotor. In that case, the electric power must be brought back to the rest of the wind power plant through electrical slip rings.

Coaxial with the centre of the circular hub, there is provided (not shown) a slip ring bearing which transfers necessary electric power to the rotor for pitch control motors, lights etc. In addition, electrical contact is provided between the rotor and the nacelle/tower for discharge current in connection with strokes of lightning. This contact may either be a slip contact or an open contact also coaxial with the centre of the circular hub with a small aperture across which a lightning stroke will be able to jump in a light arch (not shown).

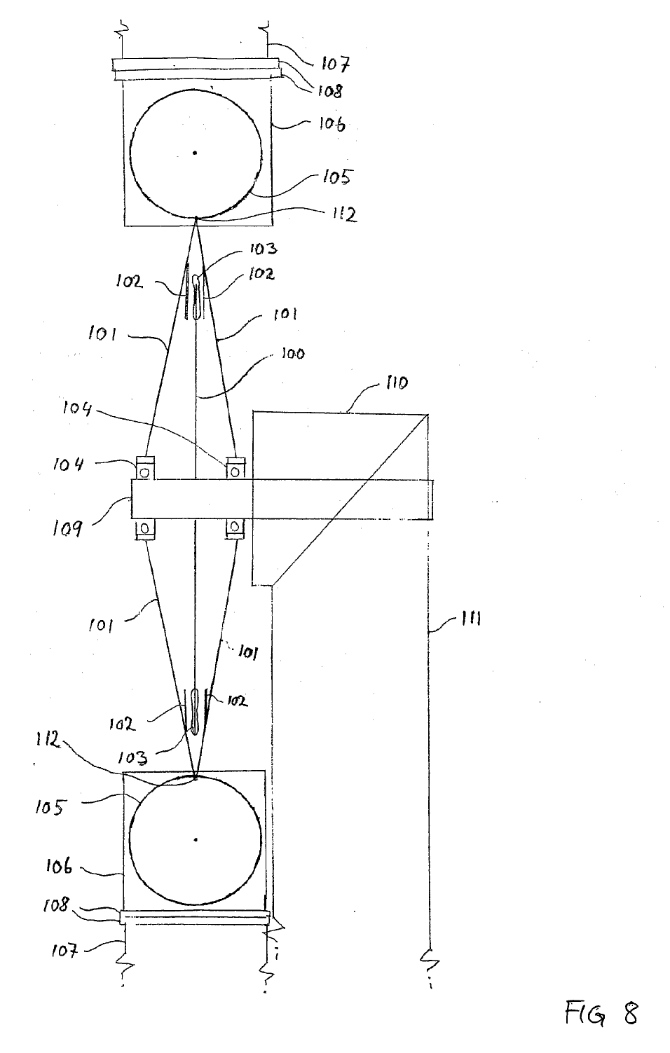

In a second embodiment of the invention the axial forces from the turbine rotor is fed into a mechanical center bearing without transferring the bending moments from the rotor blades to the center bearing. This second embodiment is shown in FIG. 8 as seen in a vertical section parallel to the rotational axis of the rotor. The blades (107) are connected to doughnut hub (105) via the pitch bearing system (108) and the mounting element (106) in a similar manner as the first embodiment. However, the structural members (101) connecting the doughnut hub to the center bearing (104) is here made rigid also in the axial directing, hence bending moments can be transferred to the central bearing. But these bending moments will be considerably smaller than for a conventional wind turbine of prior art because the bending moments at the central bearing will only be a result of the axial forces which are transferred between the doughnut hub and the structural members (101) and the radial distance from the doughnut hub at point (112) to the central bearing. No bending moments from the blades are transferred to the central bearing. This is ensured by applying a flexible connection between the doughnut and the structural members (101) at point 112 allowing the doughnut to twist in torsion (the magnitude of twist in the doughnut is typically less than 1 degree), In this way practically all the bending moments from the blades are absorbed by the doughnut hub and at the same time the rotor is still transferring the axial thrust forces from the turbine rotor to the nacelle (110) via the center bearing (104) and a fixed (non-rotating) main shaft (109).

In this manner the stator structural members (100), consisting of any suitable structural members, as a circular plate or spoke and rim system or the like, is only loaded with the power producing torque. This ensures an even lighter and less costly stator structure. The power producing electrical windings (112) and the electrical rotor magnets (102) can the be kept inside the turbine rotor. To avoid sensitivity to relative deflections between the electrical stator and the electrical rotor elements (magnets) an axial directed magnetic bearing (not shown in this figure) can be installed between the stator and the rotor in the vicinity of the power producing electrical windings, similar to the first embodiment of the invention to ensure that sufficient air gap clearance is kept at all times. It is here also advantageous to use ironless electrical windings to completely avoid any attractive forces between the electrical stator and the electrical rotor. The necessary dimention of the magnetic bearing for this embodiment is much less than for the first embodiment since the majority of the axial forces from the turbine rotor is now fed directly to the center bearing and the stator structural members (100) can be made very flexible for axial displacements (i.e. if made as a single circular plate), hence the magnetic bearing will easily deflect the stator axially as required to ensure the desired center position for the air gap in the generator.

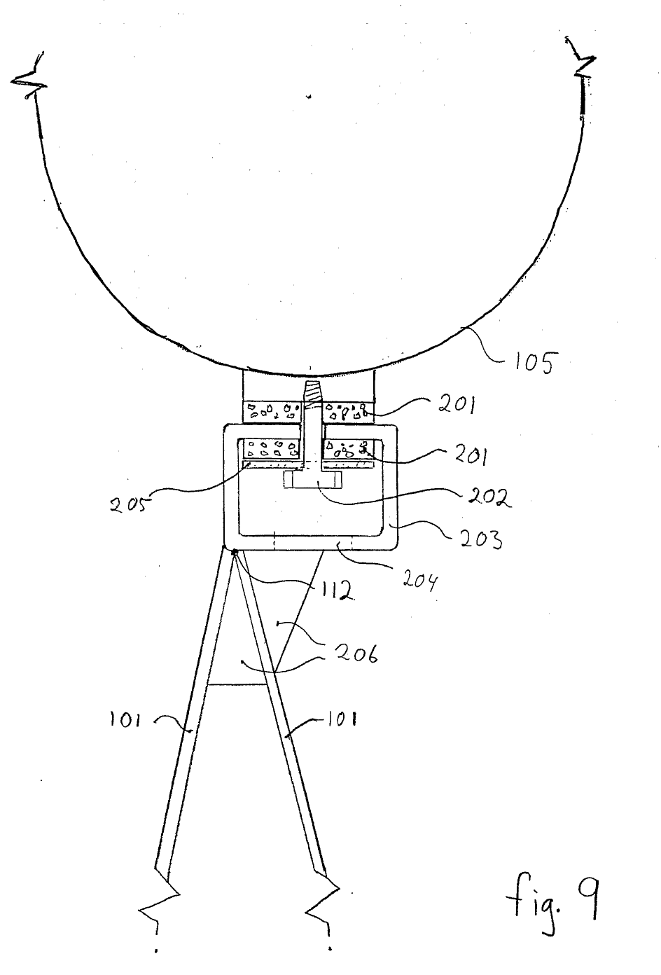

FIG. 9 shows an example of a flexible connection between the doughnut (105) and the stator structural members (101). This could be in one piece following the entire doughnuts inner circle or it can be divided in several shorter units. Flexible shim plates (201) which could be of a rubber material or the like is used to connect a structural member (203) with bolts (202) flexibly to the doughnut hub (105). A metal shim plate (205) is used to spread the loads onto the flexible material. A perforation (204) is made in the structural member (203) to be able to insert the bolts. The structural members (101) (see FIG. 9) are connected to the structural member (203). Stiffener plates (206) are used to ensure that the flexible rotations are taking place at the flexible bearing only.

With the present invention, the following advantages are obtained:
1) Substantial increase in the swept area of the rotor (and thus energy production) without increasing the length and weight of the rotor blades;
2) Dramatic increase in the diameter of the hub whilst its weight is decreased;
3) Small torsional stresses (about the axis of rotation) in the hub and shaft owing to large hub diameter;
4) Direct drive allowing the omission of a transmission unit (gear) and at the same time an increase in peripheral speed between the stator and the electrical rotor (the magnets) and thus a smaller requirement for active material in the generator;
5) Larger air gap tolerance between the stator and the electrical rotor so that this is no longer a critical parameter;
6) Direct air cooling without any need for pump systems for circulation of coolant;
7) No contact between moving parts in the main bearing or generator during operation so that wear and maintenance are substantially reduced;
8) Over 50% reduction of total weight of the rotor and generator compared with the scaling up of prior art for a 5 MW wind turbine to 10 MW.

In a first embodiment of the invention there is provided a turbine rotor for a wind or hydropower plant or for propulsive means for a vessel. The turbine rotor comprises a doughnut-shaped hub which, as seen in a cross section B, is configured as a closed and hollow torsion-proof profile. The doughnut-shaped hub is further formed either
in the shape of a torus, the torus, in cross section B, being circularly shaped and the torus, in cross section A, being ring-shaped wherein the outer and inner circumferences of the ring are circular, or
in the shape of a quasi-torus, the quasi-torus, in cross section B, being polygonally or circularly shaped and the quasi-torus, in cross section A, being ring-shaped wherein the outer and inner circumferences of the ring are polygonally or circularly shaped

On the torus or quasi-torus is there provided at least one rotor blade.

The polygonal shapes of cross sections A and/or B of the quasi-torus mentioned above, are preferably regular polygons, but these cross sections may also have irregular polygonal shapes.

The size of the torus or quasi-torus shaped hub (substantially doughnut-shaped) is made large in relation to the total diameter of the turbine rotor compared to known power plants. Preferably the distance from the axis of rotation of the turbine rotor to the outer circumference of the ring formed in cross section A of the doughnut-shaped hub, or to a circle circumscribing the outer polygon of the ring formed in cross section A of the doughnut-shaped hub if the shape of the ring is polygonal, is at least 1/12 of the radius of the turbine rotor, i.e. the distance from the axis of rotation of the turbine rotor to the tip of a blade.

The small diameter of the doughnut-shaped hub, as seen in cross section B, is preferably of substantially the same size as the diameter of the at least one blade at the root portion of the blade. The small diameter of the hub may, however, be made somewhat smaller than the diameter of the blades of the turbine rotor. Obviously, the smaller diameter can also be made larger than the diameter of the blades, but should be kept as small as possible since it is desirable to keep the weight of the turbine as low as possible. The most important though, is that the doughnut-shaped hub must be made sufficiently sturdy to take up torsional moments and bending moments caused by wind loads on the blades.

The blades of the turbine rotor may be attached directly to the doughnut-shaped hub with a pitch bearing. Another option is to make use of mounting elements which is mounted on the doughnut-shaped hub. The mounting elements is preferably formed with a through-going hole with a shape and size corresponding to the shape and size of the doughnut-shaped hub such that the mounting element surrounds the doughnut-shaped hub when the mounting element is mounted on the doughnut-shaped hub. The cut-out piece to make the through-going hole is preferable re-installed (after beveling off some of the material to take account of the wall thickness of the doughnut) at the inside of the doughnut hollow profile to act as a stiffening member. In this way structural capacity of both the doughnut and the mounting member is kept intact also after the through-going hole in the mounting member is made.

The bending moments at the root of each blade due to the wind forces is in this manner transferred to the doughnut hub as pure shear forces around the orifice of the cut-out for the through-going hole. This is a beneficial way to avoid high stress concentration in the “tubular joint” between the mounting member and the doughnut hub. The bending moments at the root of each blade due to the gravity forces of the blades are transferred as a force pair with the effective arm being the width (diameter) of the mounting member. The forces are transferred with the re-instated cut-off pieces as internal stiffening, hence ensuring a stiff and elegant joint with low stress concentration and high buckling resistance.

A rotor blade is attached to each of the mounting elements such that the rotor blades extend substantially radially away from the axis of rotation of the turbine rotor. Preferably the rotor blade is attached to the mounting element with a pitch bearing, but may also be attached to the mounting element without using a pitch bearing.

In a further embodiment of the invention the turbine rotor comprises at least two tension rods which at their first ends are attached to the doughnut-shaped hub and at their second ends are attached to a central bearing mounted on a central hub where the central bearing and central hub are coaxial with the centre axis of the stator. The tension rods are preferably arranged such that they lie in substantially the same plane, thereby transferring radial forces and very little or nothing of the axially directed forces created by the wind loads on the turbine rotor.

In stead of using tension rods the turbine rotor may instead be provided with at least two pressure rods which at their first ends are attached to the doughnut-shaped hub and at their second ends are attached to a central bearing mounted on a central hub where the central bearing and central hub are coaxial with the centre axis of the stator. The pressure rods are preferably arranged such that they lie in substantially the same plane, thereby transferring radial forces and very little or nothing of the axially directed forces created by the wind loads on the turbine rotor.

In one embodiment of the invention the generator rotor is mounted to the doughnut-shaped hub.

In another embodiment of the invention the turbine rotor comprises at least two sets of support members extending between an attachment area of the doughnut-shaped hub and at least two spaced apart central bearings respectively. The turbine rotor preferably comprises two sets of support members, but may have more than two sets, for instance four or six sets of support members. The support members may comprise rods or plates or other suitable elements and combination of different types of elements as long as they are able to transfer axial forces, due to wind loads, to the central hub on which the turbine rotor is supported. Torsional moments due to wind loads and bending moments due to the weight of the blades will be taken up in the substantially doughnut-shaped torus.

The attachment area is preferably located on the inside of the doughnut-shaped hub, on the part of the doughnut-shaped hub facing substantially towards the rotational axis of the turbine rotor. The support members are preferably mounted to the doughnut-shaped hub at the attachment area such that they are in contact with each other and thereby forming an angle α between themselves. This angle may be chosen from a wide range of values, but will be less than 90°. Preferably the angle α is less than 50° and most preferably less than 25°. If there are more than two sets of support members, each set will obviously form an angle between them which is different from the angle formed between the support members of the other sets.

Preferably magnets are attached to one or both of the at least two sets of support plates where the magnets form a part of an electric generator.

In a second aspect of the present invention there is provided a power plant comprising a direct-drive generator for converting the energy in wind or flowing water into electrical energy, the power plant comprising a tower to which a house is mounted. The house comprises a fixed, central hub and the power plant comprises a turbine rotor which is formed according to any one of claims 1-7 or 13-16. The turbine rotor is supported on at least two spaced apart bearings, and that stator of the direct drive generator is mounted on the central hub.

The stator of the direct drive generator may be mounted to the central hub between the at least two spaced apart bearings with an equal number of bearings on each side of the stator or be mounted on either side of the bearings. If the support members are constituted of plates then the area between the doughnut-shaped hub and the central hub may be completely or partly covered by the at least two sets of plates. It is also possible to provide the plates with holes.

In a third aspect of the present invention there is provided a power plant comprising a direct-drive generator for converting the energy in wind or flowing water into electrical energy. The power plant comprises a tower structure and a turbine rotor and the direct-drive generator comprises a generator rotor which is mounted on the turbine rotor. The power plant further comprises a stator which is mounted on the tower structure and a bearing which supports the turbine rotor on the stator. The turbine rotor of the power plant is formed according to any one of claims 1-15 and the turbine rotor has an axis of rotation that coincides with the centre axis of the stator of the direct-drive generator.

In one embodiment of the invention, the doughnut-shaped hub, in the shape of a torus or a quasi-torus, of the turbine rotor is supported on the stator by a magnetic bearing. This magnetic bearing may be a passive magnetic bearing or an electromagnetic bearing or a combination of the two. In an embodiment of the invention the bearing may also be a conventional bearing.

In another embodiment of the invention, the doughnut-shaped hub is supported by a magnetic bearing axially against the stator in order to take up axial forces and global bending moments caused by different wind pressure on each rotor blade while the doughnut-shaped hub is supported radially by means of a conventional bearing which takes up radial forces.

In order to take up the radial forces, the wind turbine rotor may comprise at least two tension rods or at least two pressure rods as already described where they in one end are attached to a central bearing provided on a central hub, the central bearing and the central hub being coaxial with the centre axis of the stator, and at the other ends are attached to the doughnut-shaped hub. The tension or pressure rods lie preferably in substantially the same plane in order to substantially transmit only radial forces as most of the axial forces will be taken up by the magnetic bearing. Another option is to use rods without any pre-tension (pressure or tension).

In another embodiment of the present invention the magnetic bearing is a passive magnetic bearing with the magnets arranged in a Halbach array.

In still another embodiment of the present invention the magnets in the stator are replaced by short-circuited electrical conductors.

In a further embodiment of the present invention the current-producing windings are installed without magnetically conducting iron cores.

In still a further embodiment of the present invention the generator magnets preferably consist of permanent magnets arranged in a Halbach array.

In a further embodiment of the invention, the shortest distance from the axis of rotation of the doughnut-shaped hub to the area centre of the force transferring face of the magnetic bearing is smaller than the distance from the axis of rotation of the doughnut-shaped hub to the neutral axis for torsion of the cross-section of the doughnut-shaped hub. Such a positioning of the magnetic bearings means that displacements of the rotor part of the magnetic bearing in an axial direction counteract each other because of bending and torsion in the doughnut-shaped hub caused by the wind forces on the rotor. Local bending of the hub around each blade draws the bearing locally in the direction of the wind, whilst torsional twisting of the hub cross-section causes the bearing to be displaced against the direction of the wind. When ideally positioned (angle α in FIG. 8), axial displacements of the magnetic bearing which is connected to the hub can neutralise each other wholly or partly. This is an advantage so that the magnetic bearing faces are maintained as level (plane) as possible, thereby ensuring that they do not come into contact with each other locally owing to deflections of the hub.

In a further embodiment of the present invention, in order to reduce the risk of the generator rotor getting into contact with the generator stator, the bending stiffness of the doughnut-shaped hub for bending out of a plane that is perpendicular to the axis of rotation of the doughnut-shaped hub is greater than the bending stiffness of the stator for bending out of the same plane. When the stator has a bending stiffness which is less than bending stiffness of the doughnut-shaped hub the stator will tend to follow local deflections in the doughnut-shaped hub due to wind loads on the wind turbine and thereby reducing the risk that the rotor and the stator getting in contact. In other words, this means that the magnetic bearing has a local flexibility and the stator can be deflected locally if magnets in an area of the magnetic bearing approach contact with each other. In a preferred embodiment of the invention, the bending stiffness of the doughnut-shaped hub for bending out of a plane that is perpendicular to the axis of rotation of the doughnut-shaped hub is at least twice as great as the bending stiffness of the stator for bending out of the plane.

A fifth aspect of the present invention comprises the use of the turbine rotor according to any of the claims 1-16 in a wind power plant or a hydro power plant.

A sixth aspect of the present invention comprises the use of the turbine rotor according to any of the claims 1-16 as a propulsive means on a vessel.

Presented below is a description of non-limiting examples of preferred embodiments of the invention that are illustrated in the attached drawings, wherein:

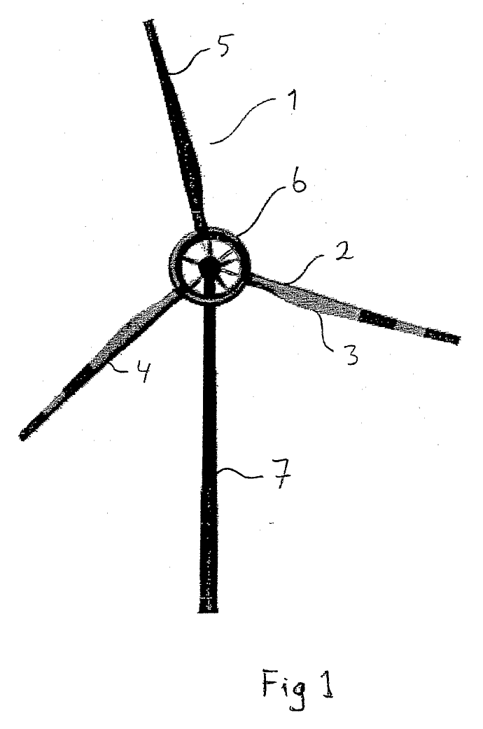

FIG. 1 illustrates a wind power plant with a wind turbine rotor consisting of rotor blades and hub. The wind power plant is mounted on a tower 7. The tower may either have a fixed foundation or be installed floating offshore.

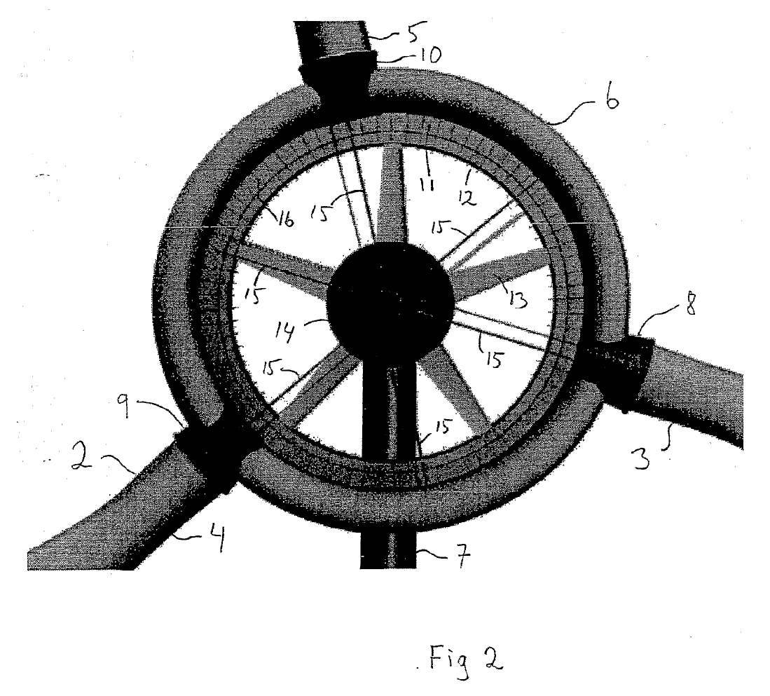

FIG. 2 illustrates the wind turbine rotor with blades mounted in pitch bearings.

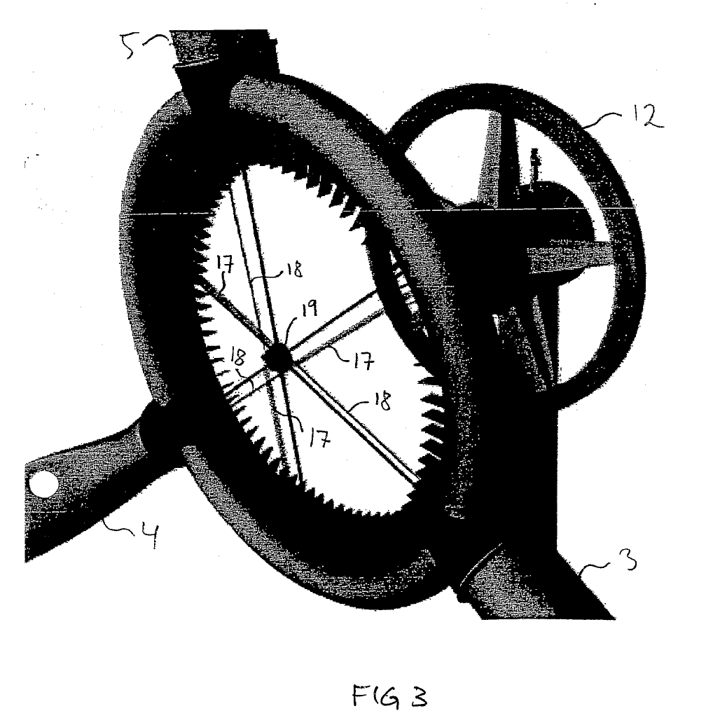

FIG. 3 is a perspective view of a rotor dismantled from a stator,

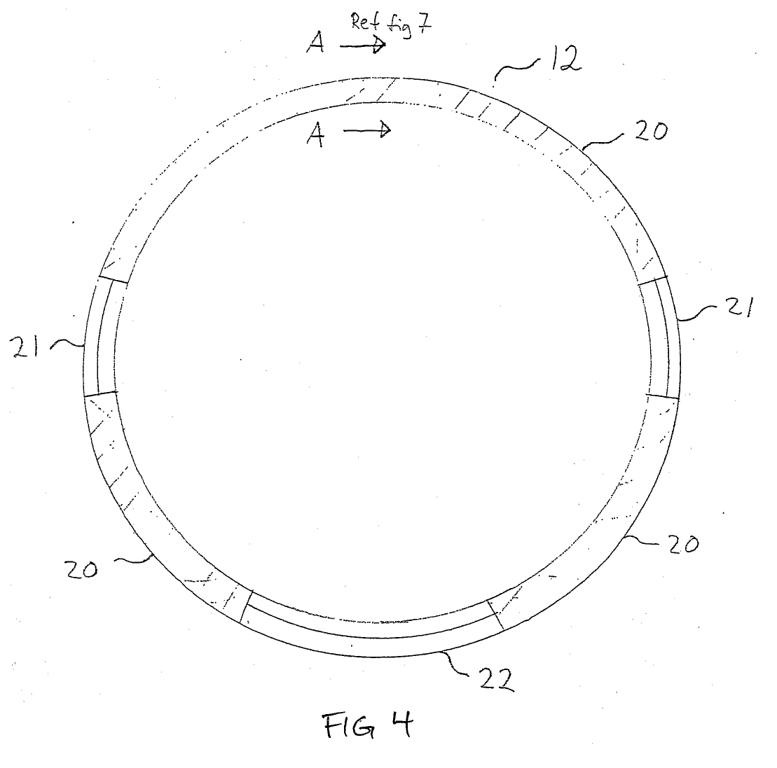

FIG. 4 illustrates the stator alternatively divided into different areas,

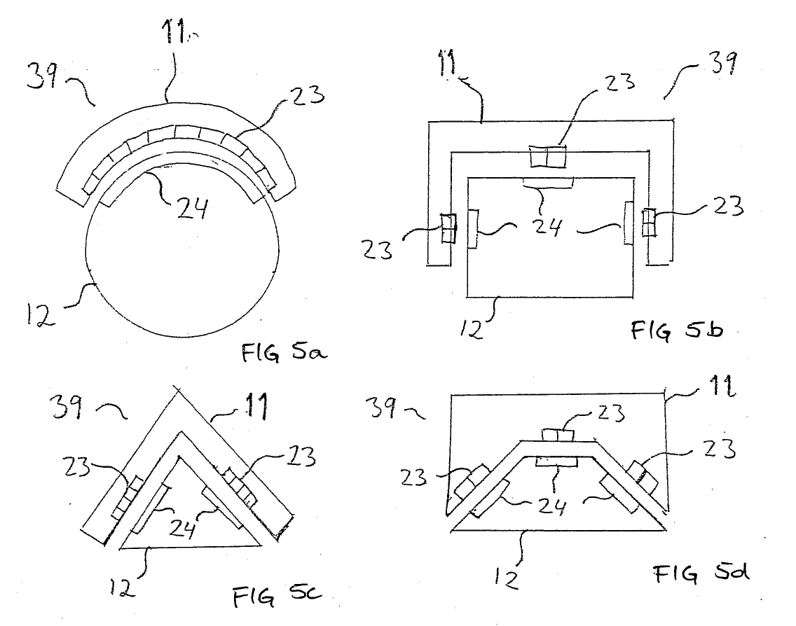

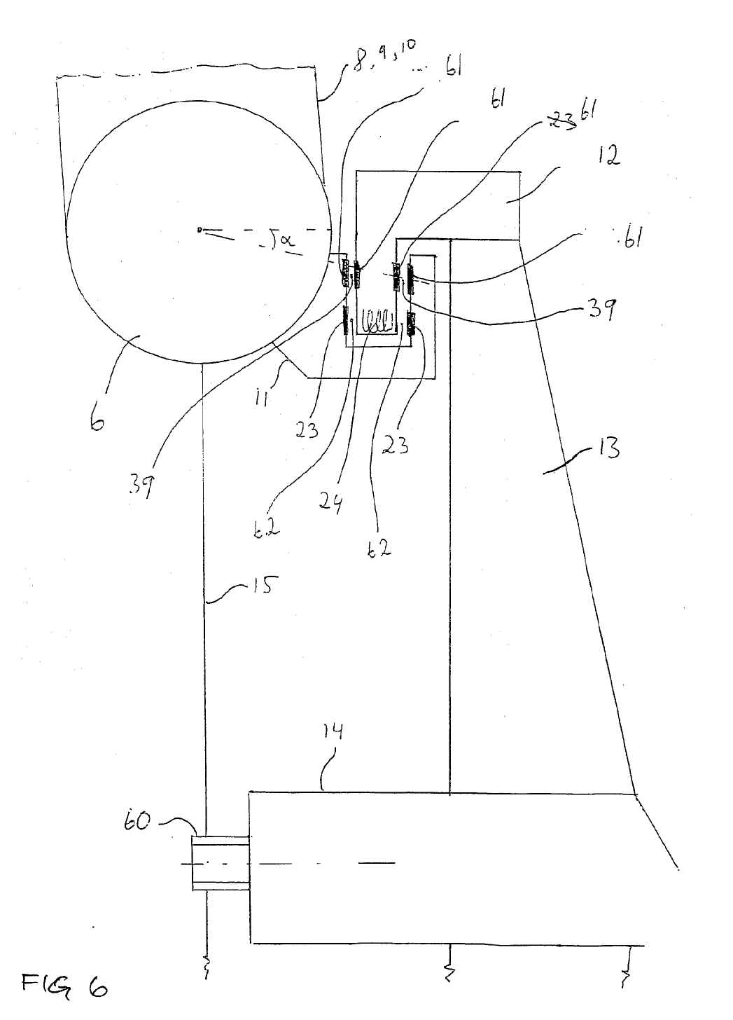

FIG. 5a-d illustrates four alternative cross-sections (cross-section A-A as indicated in FIG. 6) of the combined magnetically stable bearing and generator,

FIG. 6 illustrates combined axial magnet bearing and radial mechanical bearing,

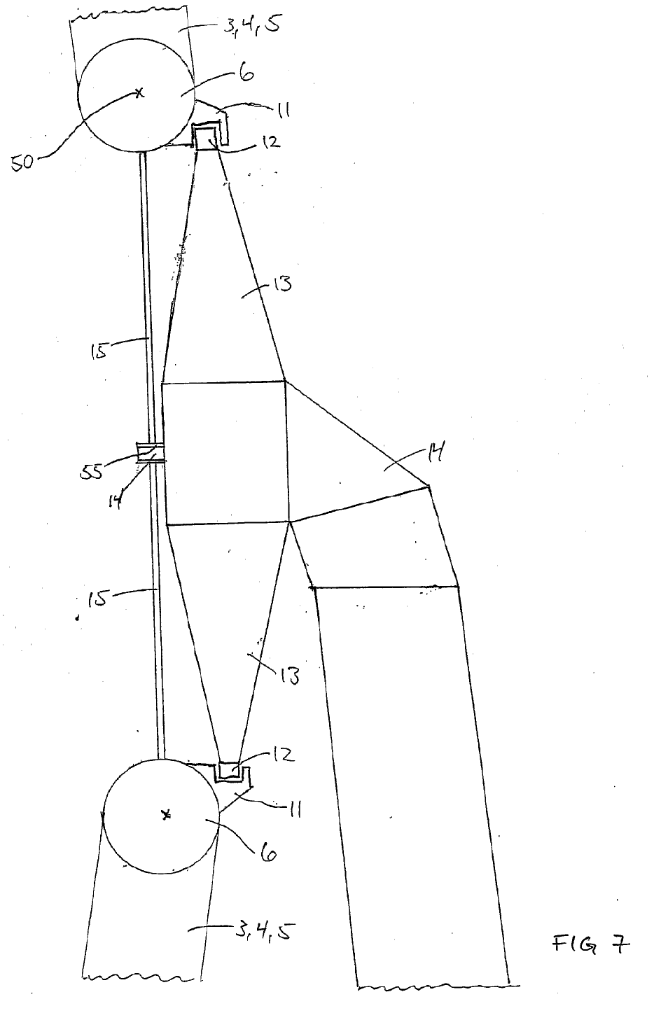

FIG. 7 is a side view of a section of a wind power plant,

FIG. 8 illustrates a second embodiment of the invention,

FIG. 9 shows an example of a flexible connection between the doughnut-shaped hub and the stator structural members,

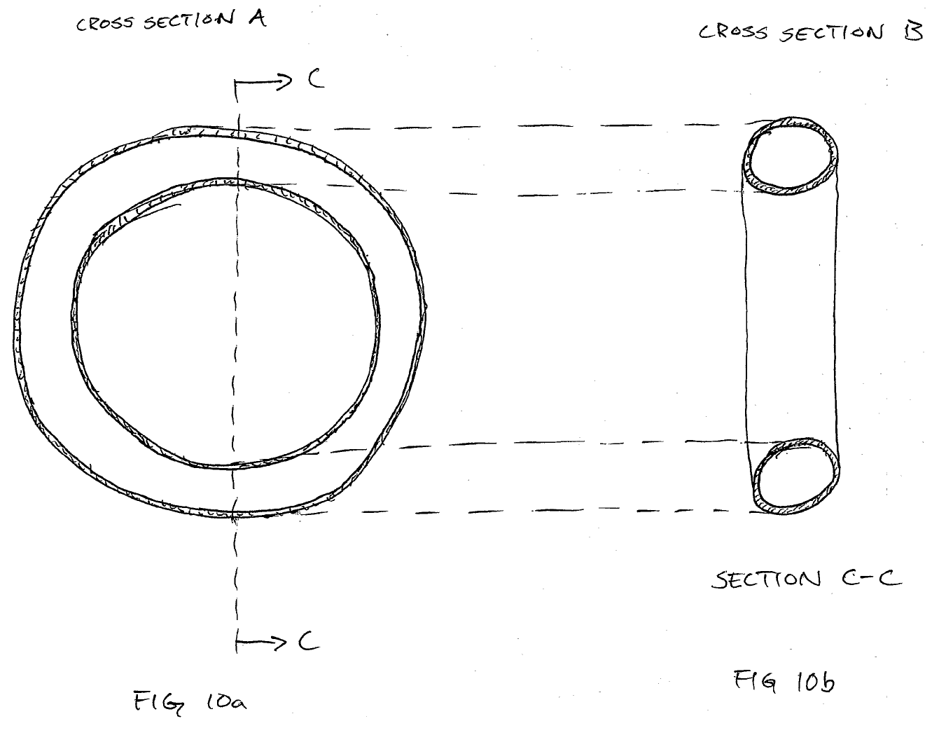

FIGS. 10-13 illustrates different possible combinations of the shape of the doughnut in cross section A and cross section B.

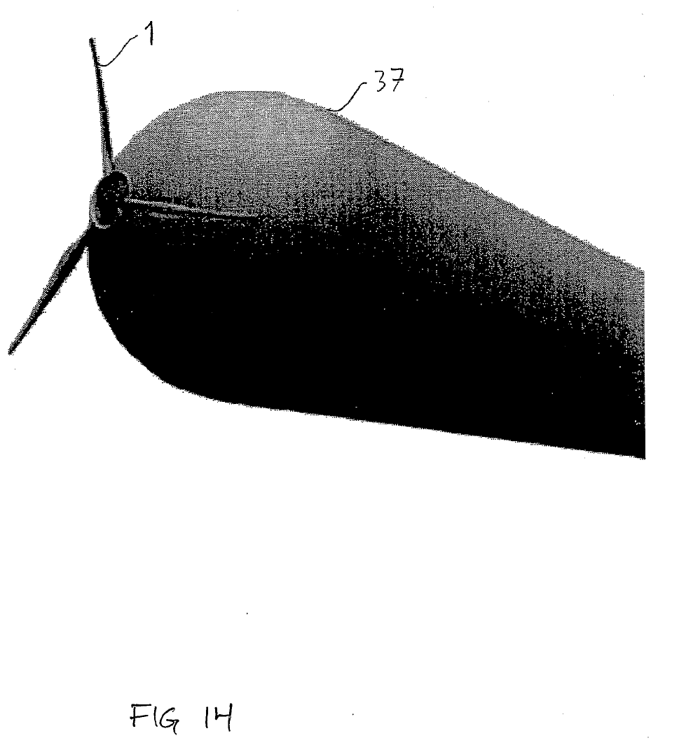

FIG. 14 illustrates an arrangement where the wind power plant is used as a propulsion system for a vessel in air or water,

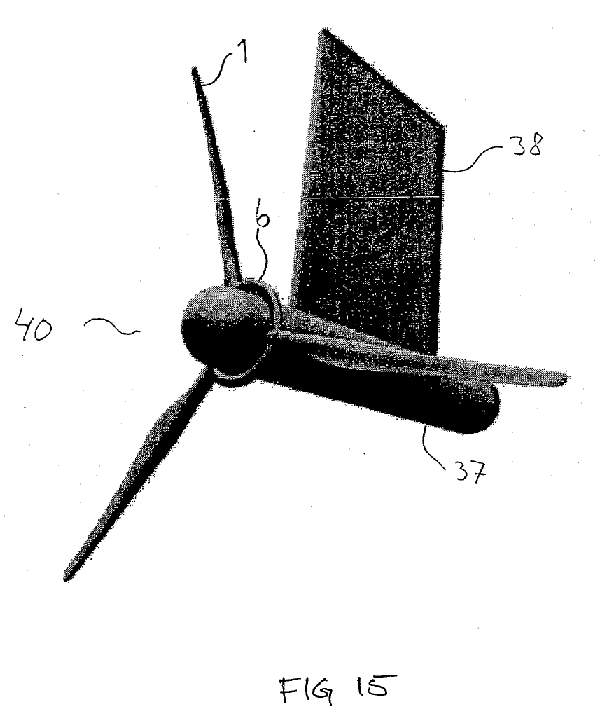

FIG. 15 illustrates a propulsion system where the hub surrounds a part of or the whole of the vessel's hull.

In the following, the first embodiment of the present invention refers to the embodiment wherein the doughnut-shaped hub is supported on the stator with at least partly a magnetic bearing, as shown in for instance FIGS. 6 and 7, while the second embodiment of the invention refers to the embodiment wherein the doughnut-shaped hub is supported on a central hub as shown in FIG. 8.

FIG. 1 shows a wind power plant 1 with an output of 10-12 MW that is equipped with a large generally doughnut-shaped hub 6, 105, where the doughnut-shaped hub can have a diameter in the order of 20 meters. The doughnut-shaped hub 6, 105 may have a diameter in the order of 3 meters taken in cross-section B. The rotor blades 3, 4, 5 may have a length of 60 m each and are disposed against pitch bearings 8, 9, 10, as shown in FIG. 2, which are arranged to be able to turn the blades about their longitudinal axis on an impulse from a pitch control system (not shown). The blades may be attached to the doughnut-shaped hub using a mounting element 106 as shown in for instance FIG. 8. The pitch bearings are arranged in the mounting elements 106 on the doughnut-shaped hub 6 with an angle of 120 degrees between each blade 3, 4, 5. The doughnut-shaped hub 6, 105 is a closed and hollow profile which may consists of a hollow circular tube as shown in FIGS. 10a and 10b, wherein the outer circle (section A) has a diameter of about 15% of the diameter of the turbine rotor and the tube has a cross-section of about 100% of the cross-section of the blades 3, 4, 5 at their attachment to the pitch bearing. On the inside of the doughnut-shaped hub 6 of the first embodiment there is arranged an electrical rotor 11 which is supported against a stator part 12. The stator 12 is supported by bending-stiff beams 13 which conduct the forces into the rest of the supporting structure via a cylindrical tube 14. The rotor and stator are equipped with naturally ventilated cooling ribs 16.

The load-bearing cross-section of the doughnut-shaped hub 6, 105 consists of a closed circular, hollow profile of about 3 meters in diameter which is adapted to simultaneously take up large torsional moments and bending moments, caused by weight and wind loads on the rotor blades. In the first embodiment of the invention stator 12 is supported by bending-stiff beams 13 which conduct the forces into the rest of the supporting structure via a cylindrical tube 14. Each pitch bearing is connected to the opposite side of the doughnut-shaped hub 6 via tension rods or pressure rods 15, all of which are connected to each other in a central anchor ring or anchor plate 60 which is radially supported mechanically against a cylindrical tube 14. The tension rods or pressure rods 15 lie in substantially the same plane so that the tension or pressure rods do not transfer axial forces (unlike a bicycle wheel where the spokes are mounted against the central hub in two different positions axially to be able to take up axial forces). The axial forces from the rotor caused by the wind pressure against the blades 3, 4 and 5 are transferred directly to the stator 12 via an axially aligned magnetic bearing 39 between the doughnut-shaped hub 6 and the stator 12. This magnetic bearing consists of oppositely directed permanent magnets so that repellent forces arise in the bearing faces. The bearing is advantageously made double-acting, i.e., that it takes up forces in both axial directions. Four rows of magnets may then be used in the bearing in order to achieve this. Alternatively, electromagnets can be used in the bearing. The torque M_{T} of the turbine rotor which causes energy production is taken up directly in the stator 12 without passing via a central shaft. The fixed shaft 12 is therefore identical with the generator stator and consists of a short annular ring with a large peripheral diameter, adapted to the peripheral diameter of the doughnut-shaped hub 6, arranged directly against the motor housing 14 or supporting structure 7 of the wind power plant via beams 13. The damping of the rotor 2 and the hub 6 in the rotor plane (defined here as a plane that intersects the outer tip of the three blades) is carried out by active modulation of the generator power output by means of the control system of a power transformer (rectifier/inverter, not shown), optionally together with an aerodynamic brake which provides aerodynamic damping in the rotor plane. Elements from known generator technology with which a person of skill in the art will be familiar, can be used together with this invention without this being described in more detail here. These elements may, e.g., be inclined stator windings or magnets, or an irregular distance between the magnets or the stator windings in order to avoid cogging etc, but are not limited thereto.

The main bearing 39 is a stable magnetic bearing consisting of permanent magnets 61 as shown in FIG. 6 which are directed towards each other so that repelling forces are produced between them.

Although the electrical windings in the stator preferably are generally ironless, they may nevertheless alternatively contain iron cores in the areas 21, 22.

If there is a purely magnetic bearing in both the radial and axial direction (with a Halbach array), a mechanical bearing (not shown) can also be provided between the electrical rotor 11 and the stator 12 which supports the electrical rotor both axially and radially until it has reached sufficient speed for the passive magnetic bearing to become active.

The permanent magnets 23 and 61 are fastened against a rubber base in order to provide radial and axial damping in the magnetically stable bearing.

FIG. 6 shows a preferred cross-section (cross-section A-A as indicated in FIG. 4) of the combined magnetically stable bearing and generator consisting of electrical generator 62 composed of stator ring (mounted on rim) 12 with electrical windings 24 without iron cores and permanent magnets 23 on the rotor. The electrical rotor 11 with permanent magnets 23 is a part of and fastened directly to the doughnut-shaped hub 6.

FIGS. 5a, 5b, 5c and 5d show alternative cross-sections (cross-section A-A as indicated on FIG. 6) of the combined magnetically stable bearing and generator.

FIGS. 6 and 7 are side views of a wind power plant with the doughnut-shaped hub 6 with the electrical generator 11 arranged on the doughnut-shaped hub 6. The electrical rotor 11 is attached to the doughnut-shaped hub 6. The electrical rotor is configured with an annular recess in which the stator 12 lies. This recess may have the form of a U which either points upwards (FIG. 6) or downwards (FIG. 7). To increase available magnetic area, it is also possible to make the generator and the magnetic bearing in the form of several axially successive discs consisting of a plurality of recesses in the axial direction and with a plurality of associated stator rings. The electrical rotor 11 and the stator 12 are provided with magnets which together form a magnetic bearing which takes up axial forces and bending moments caused by wind loads. The electrical generator 11 the stator 12 also comprise the current producing elements, i.e., magnets and stator windings. It is also conceivable that the windings are arranged on the electrical rotor and the magnets on the stator. The annular recess in the electrical rotor 11 and the stator 12 may have different designs, for example as shown in FIGS. 5a-d and FIG. 6.

To take up radial forces, in particular the weight of the turbine rotor, there are provided tension or pressure rods 15 which are fastened to the doughnut-shaped hub 6 at one end and to a central anchor ring or anchor plate 55 at the other end, wherein the anchor ring or anchor plate 55 is radially supported mechanically against a cylindrical tube 14.

On the doughnut-shaped hub, the turbine rotor blades 3, 4, 5 are also mounted on their respective pitch bearings.

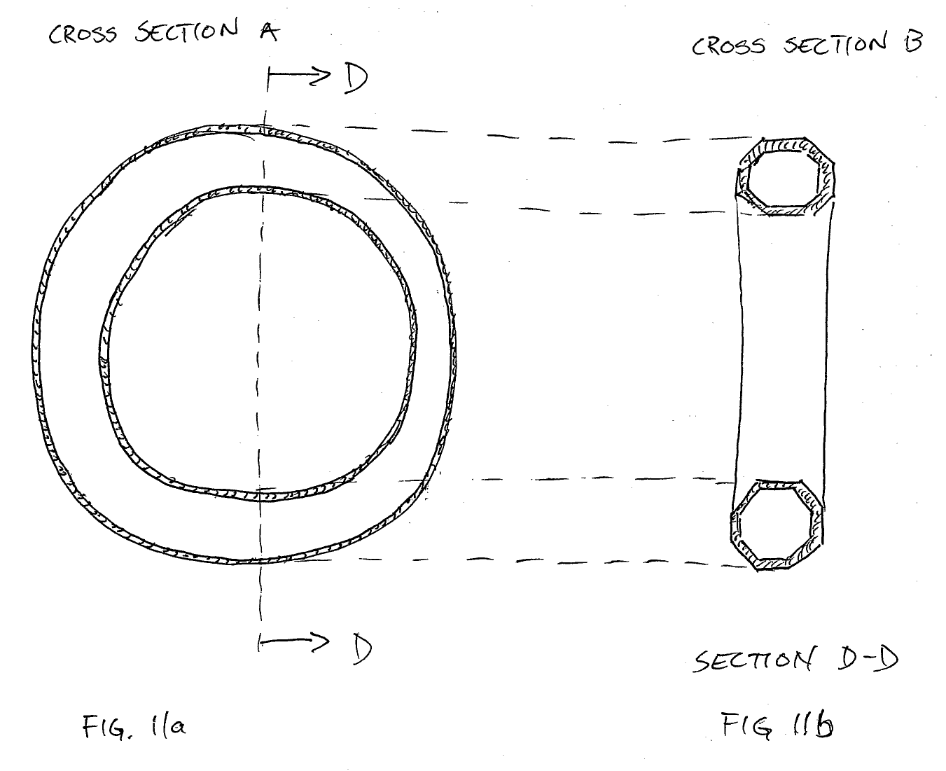

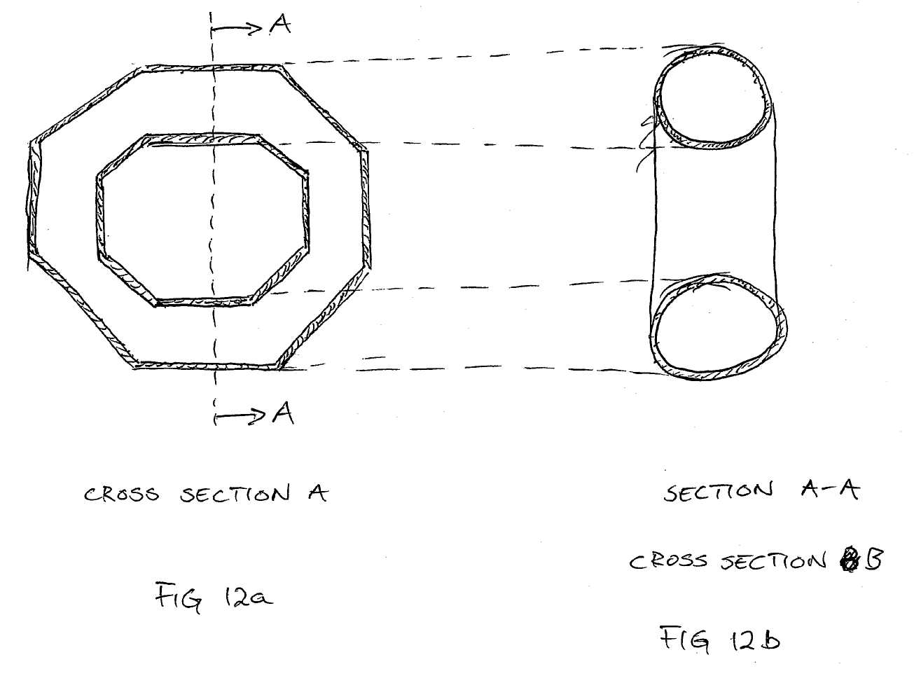

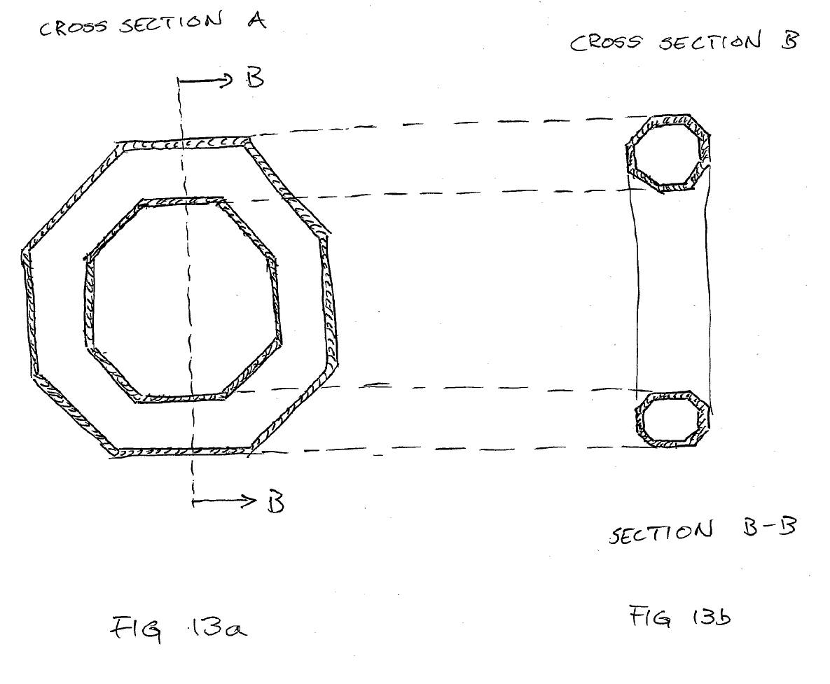

FIGS. 10-13 shows different configurations of the generally doughnut-shaped hub 6, 105 which is given the shape of a proper torus or a quasi-torus. As explained earlier, there are two important cross sections—cross section A and cross section B. As can be seen from the figures, the two cross sections A and B may be given a circular or a polygonal shape. The polygonal shape is preferably regular, for instance pentagon, hexagon and so on. The different possible combinations circular and polygonal shapes are given in the FIGS. 10-13. FIG. 10a-10b shows the doughnut-shaped hub 6, 105 where the shape is circular for both cross section A and cross section B. In this instance the doughnut-shaped hub has the form of a proper torus. FIGS. 10a-10b shows the doughnut-shaped hub 6, 105 where one of cross sections A or B is circularly shaped and the other polygonally shaped (FIGS. 11-12) and the last option where both cross section A and cross section B is polygonally shaped (FIG. 13). The doughnut-shaped hub shown in FIGS. 11-13 has the form of a quasi-torus.

In FIG. 8 a second embodiment of the invention is shown where the axial forces from the turbine rotor is fed into a mechanical central bearing without transferring the bending moments from the rotor blades to the center bearing. This second embodiment is shown in FIG. 8 as seen in a vertical section parallel to the rotational axis of the rotor. The blades 107 are connected to doughnut hub 105 via the pitch bearing system 108 and the mounting element 106 in a similar manner as the first embodiment. However, the structural members 101 connecting the doughnut hub to the center bearing 104 is here made rigid also in the axial directing, hence bending moments can be transferred to the central bearing. But these bending moments will be considerably smaller than for a conventional wind turbine of prior art because the bending moments at the central bearing will only be a result of the axial forces which are transferred between the doughnut hub and the structural members 101 and the radial distance from the doughnut hub at point 112 to the central bearing. No bending moments from the blades are transferred to the central bearing. This is ensured by applying a flexible connection between the doughnut and the structural members 101 at point 112 allowing the doughnut to twist in torsion (the magnitude of twist in the doughnut is typically less than 1 degree), In this way practically all the bending moments from the blades are absorbed by the doughnut hub and at the same time the rotor is still transferring the axial thrust forces from the turbine rotor to the nacelle 110 via the center bearing 104 and a fixed (non-rotating) main shaft 109.

In this manner the stator structural members 100, consisting of any suitable structural members, as a circular plate or spoke and rim system or the like, is only loaded with the power producing torque. This ensures an even lighter and less costly stator structure. The power producing electrical windings 112 and the electrical rotor magnets 102 can the be kept inside the turbine rotor. To avoid sensitivity to relative deflections between the electrical stator and the electrical rotor elements (magnets) an axial directed magnetic bearing (not shown in this figure) can be installed between the stator and the rotor in the vicinity of the power producing electrical windings, similar to the first embodiment of the invention to ensure that sufficient air gap clearance is kept at all times. It is here also advantageous to use ironless electrical windings to completely avoid any attractive forces between the electrical stator and the electrical rotor. The necessary dimention of the magnetic bearing for this embodiment is much less than for the first embodiment since the majority of the axial forces from the turbine rotor is now fed directly to the center bearing and the stator structural members 100 can be made very flexible for axial displacements (i.e. if made as a single circular plate), hence the magnetic bearing will easily deflect the stator axially as required to ensure the desired center position for the air gap in the generator.

FIG. 9 shows an example of a flexible connection between the doughnut 105 and the stator structural members 101. This could be in one piece following the entire doughnuts inner circle or it can be divided in several shorter units. Flexible shim plates 201 which could be of a rubber material or the like is used to connect a structural member 203 with bolts 202 flexibly to the doughnut hub 105. A metal shim plate 205 is used to spread the loads onto the flexible material. A perforation 204 is made in the structural member 203 to be able to insert the bolts. The structural members 101 (see FIG. 9) are connected to the structural member 203. Stiffener plates 206 are used to ensure that the flexible rotations are taking place at the flexible bearing only.

The invention can also be used as a propulsion system for aircraft and all types of craft and boats that are in water. The turbine rotor 2 with the doughnut-shaped hub 6, pitch bearings 8, 9, 10 and magnetic bearing 39 in this instance of the invention will be arranged as a propeller. The size, strength and torsion/gradient etc. of the propeller are altered according to the prior art for this purpose. The generator is then run as an electric motor. The propulsion system is arranged on a vessel 37 which is to be moved by means of the propulsion system, where two examples are shown in FIGS. 14 and 15. On the vessel 37 or the hull, in one variant of the invention, a streamlined connection can be mounted to possible other parts of the object/hull that is to be moved. In another variant of the invention, the propulsion system 40 is arranged with a rudder (not shown). In yet another variant of the invention, the propulsion system 40 is arranged so that the propulsion system itself can be turned about the vertical axis in a rotatable attachment to the vessel as an azimuth propeller. Many other configurations for mounting a propeller according to the prior art will be possible. The propeller may have fewer or more blades than the preferred embodiment illustrated here. The vessel 37 may also be provided with several propellers.

1. A turbine rotor for a wind or hydropower plant or for propulsive means for a vessel, wherein the turbine rotor comprises a generally doughnut-shaped hub, which doughnut-shaped hub is configured as a closed, hollow profile in cross section B, and wherein the doughnut-shaped hub is formed either
in the shape of a torus, the torus being circularly shaped in cross section B and the torus being ring-shaped in cross section A wherein the outer and inner circumferences of the ring are circular, or
in the shape of a quasi-torus, the quasi-torus being polygonally or circularly shaped in cross section B and the torus being ring-shaped in cross section A wherein the outer and inner circumferences of the ring are polygonally or circularly shaped,
on which torus or quasi-torus at least one rotor blade is provided.

2. A turbine rotor according to claim 1, wherein the polygonal shapes of cross sections A and/or cross sections B of the quasi-torus are regular polygons.

3. A turbine rotor according to claim 1, wherein the distance from the axis of rotation of the turbine rotor to the outer circumference of the ring formed in cross section A of the doughnut-shaped hub, or to a circle circumscribing the outer polygon of the ring formed in cross section A of the doughnut-shaped hub if the shape of the ring is polygonal, is at least 1/12 of the radius of the turbine rotor, i.e. the distance from the axis of rotation to a blade tip.

4. A turbine rotor according to claim 1, wherein the small diameter of the doughnut-shaped hub is of substantially the same size as the diameter of the at least one blade at the root portion of the blade.

5. A turbine rotor according to claims 1, wherein at least one mounting element is mounted on the doughnut-shaped hub, the mounting element being formed with a through-going hole with a shape and size corresponding to the shape and size of the doughnut-shaped hub such that the mounting element surrounds the doughnut-shaped hub when the mounting element is mounted on the doughnut-shaped hub.

6. A turbine rotor according to claim 5, wherein a rotor blade is attached to the mounting element, the rotor blade extending substantially away from the axis of rotation of the turbine rotor.

7. A turbine rotor according to claim 6, wherein the rotor blade is attached to the mounting element with a pitch bearing.

8. A turbine rotor according to claim 1, wherein the turbine rotor comprises at least two tension rods which at their first ends are attached to the doughnut-shaped hub and at their second ends are attached to a central bearing mounted on a central hub, the central bearing and central hub being coaxial with the centre axis of the stator.

9. A turbine rotor according to claim 8, wherein the tension rods lie in substantially the same plane.

10. A turbine rotor according to claim 1, wherein the turbine rotor comprises at least two pressure rods which at their first ends are attached to the doughnut-shaped hub and at their second ends are attached to a central bearing mounted on a central hub, the central bearing and central hub being coaxial with the centre axis of the stator.

11. A turbine rotor according to claim 10, wherein the pressure rods lie in substantially the same plane.

12. A turbine rotor according to claim 1, wherein the generator rotor is mounted to the doughnut-shaped hub.

13. A turbine rotor according to claim 1, wherein the turbine rotor comprises at least two sets of support members extending between an attachment area of the doughnut-shaped hub and at least two spaced apart central bearings respectively.

14. A turbine rotor according to claim 13, wherein the attachment area is located on the part of the doughnut-shaped hub facing substantially towards the rotational axis of the turbine rotor.

15. A turbine rotor according to claim 13, wherein an angle α is formed between the two sets of support members, in cross section B, which is less than 90°, preferably less than 50°, most preferably less than 20°.

16. A turbine rotor according to claim 13, wherein magnets are attached to one or both of the at least two sets of support members, the magnets forming a part of an electric generator.

17. A power plant comprising a direct-drive generator for converting the energy in wind or flowing water into electrical energy, the power plant comprising a tower to which a house is mounted, the house comprising a fixed, central hub, the power plant further comprising a turbine rotor, wherein the turbine rotor is formed according to any one of claims 1-7 or 13-16, and that the turbine rotor is supported on at least two spaced apart bearings provided on the central hub and that stator of the direct drive generator is mounted on the central hub.

18. A power plant according to claim 17, wherein the stator of the direct drive generator is mounted to the central hub between the at least two spaced apart bearings with an equal number of bearings on each side of the stator.

19. A turbine rotor according to one of claim 17 or 18, wherein the area between the doughnut-shaped hub and the central hub is completely or partly covered by the at least two sets of support plates.

20. A power plant comprising a direct-drive generator for converting the energy in wind or flowing water into electrical energy, the power plant comprising a tower structure and a turbine rotor, the direct-drive generator comprising a generator rotor which is mounted on the turbine rotor, a stator which is mounted on the tower structure and a bearing supporting the turbine rotor on the stator, wherein the turbine rotor is formed according to any one of claims 1-15 and the turbine rotor having an axis of rotation that coincides with the centre axis of the stator of the direct-drive generator.

21. A power plant according to claim 20, wherein the turbine rotor is supported on the stator by a magnetic bearing consisting of either permanent magnets, electromagnets or a combination of both.

22. A power plant according to claim 21, wherein the magnetic bearing is a passive magnetic bearing.

23. A power plant according to claim 21, wherein the magnetic bearing is a passive magnetic bearing with the magnets arranged in a Halbach array.

24. A power plant according to one of claim 21 or 23, wherein the magnets in the stator are replaced by short-circuited electrical conductors.

25. A power plant according to claim 21, wherein the magnetic bearing is an electromagnetic bearing.

26. A power plant according to claim 21, wherein the current-producing windings are installed without magnetically conducting iron cores.

27. A power plant according to claim 26, wherein the generator magnets consist of permanent magnets arranged in a Halbach array.

28. A power plant according to claim 20, wherein the turbine rotor is supported on the stator by a conventional bearing.

29. A power plant according to claim 20, wherein the turbine rotor is supported by a magnetic bearing axially against the stator and that the turbine rotor is supported radially by a conventional bearing.

30. A power plant according to claim 21, wherein the shortest distance from the axis of rotation of the doughnut-shaped hub to the area centre of the force transferring face of the magnetic bearing is smaller than the distance from the axis of rotation of the doughnut-shaped hub to the neutral axis of the cross-section of the doughnut-shaped hub.

31. A power plant according to claim 21, wherein the bending stiffness of the doughnut-shaped hub for bending out of a plane that passes through the doughnut-shaped hub and is perpendicular to the axis of rotation of the doughnut-shaped hub is greater than the bending stiffness of the stator for bending out of the same plane.

32. A power plant according to claim 21, wherein the bending stiffness of the doughnut-shaped hub for bending out of a plane that runs through the doughnut-shaped hub and is perpendicular to the axis or rotation of the doughnut-shaped hub is at least twice as great as the bending stiffness of the stator for bending out of the same plane.

33. (canceled)

34. (canceled)
